(19) United States
(12) Patent Application Publication
(10) Pub. No.: US 2016/0168879 A1
(43) Pub. Date: Jun. 16, 2016

(54) LOCKER ASSEMBLY FOR DOOR BOARDS

(71) Applicant: Shanghai MingWei Hardware Co., Ltd., Shanghai (CN)

(72) Inventors: Lawrence CHEN, Shanghai (CN); You-Gen YING, Shanghai (CN)

(21) Appl. No.: 14/566,905

(22) Filed: Dec. 11, 2014

(51) Int. Cl. E05B 65/10; E05C 1/02

(52) U.S. Cl. CPC E05B 65/1006; E05C 1/02

(57) ABSTRACT

A locker assembly is mounted outside to a door board having a penetration hole for cooperating with one of an embedded lock casing, an embedded vertical extended-rod locking assembly and an exposed vertical extended-rod locking assembly mounted on the door board. The locker assembly includes a base, a sliding unit, a fixation base structure, a toggle coupled with the fixation base structure and a rocker arm. The base has a through aperture and applies the sliding unit to adopt commonly the locker assembly. The sliding unit can assemble a turning application rod penetrating both the through aperture and the penetration hole. While the rocker arm is depressed, the toggle rotates to slide the sliding unit and so as further to drive the turning application rod inside the through aperture and the penetration hole to further perform the unlocking of the door board.

### BACKGROUND OF INVENTION

1. Field of the Invention

The invention relates to a locker assembly for door boards, and more particularly to a universal the locker assembly for door boards that can be applicable to the locker types of the embedded lock casing, the embedded vertical extended-rod locking assembly and the exposed vertical extended-rod locking assembly.

2. Description of the Prior Art

Generally, fire doors are common to various buildings. While in meeting a fire, the fire door can be manually unlocked for evacuation. Currently, installation types of the locker assembly of the fire doors includes the embedded lock casing, the embedded vertical extended-rod locking assembly and the exposed vertical extended-rod locking assembly, either by horizontal mounting or by three-point mounting. The embedded lock casing is to be mounted inside the fire door, and provides an extendable locking tongue for horizontally or rotationally locking the door. The embedded vertical extended-rod locking assembly is also mounted inside the fire door, and provides vertical-moving locking rods to lock the door. Contrarily, the exposed vertical extended-rod locking assembly is mounted outside the fire door, and provides similar vertical-moving locking rod to lock the door.

Naturally, to meet various installation needs, different locker assembles shall be applied to lock/unlock the corresponding fire doors. For example, referring to FIG. 1, a conventional locker assembly installed on a fire door is perspective shown. The conventional locker assembly PA1 mounted on a fire door PA2 includes a depression arm PA11 and a sliding member PA12. Specifically, the fire door PA2 is equipped with an exposed vertical extended-rod locking assembly (not totally shown in the figure), and the exposed vertical extended-rod locking assembly furnishes a locking rod PA3 to couple with the sliding member PA12. While the locked locking rod PA3 is to be open or unlocked, the depression arm PA11 is depressed so as to displace the sliding member PA12 to move along a sliding direction (not shown herein). The sliding motion of the sliding member PA12 would move synchronously the locking rod PA3 so as to unlock the fire door PA2. It is noted that the sliding direction shall be perpendicular to the floor and follow a vertical direction in response to the needs of the locker assembly.

Referring now to FIG. 2, another conventional locker assembly PA4 is applied to an embedded vertical extended-rod locking assembly of a fire door PA2. By compared to the conventional locker assembly PA1 of FIG. 1 that is mainly mounted exteriorly to the door and thus applicable simply to the exposed vertical extended-rod locking assembly, the embedded vertical extended-rod locking assembly PA4 for the fire door PA2 needs another relevant locker assembly to drive the interior sliding member PA41 so as to lock or unlock the fire door PA2. It is obvious that the aforesaid locker assembly PA1 is no more suitable to the current sliding member PA41. Hence, a more appropriate locker assembly or mechanism shall be introduced to serve this embedded vertical extended-rod locking assembly PA4. In the art, such an improvement is expensive and thus needs further modification.

### SUMMARY OF THE INVENTION

Hence, to meet various needs of locking assembly for the door boards, a universal locker assembly shall be a solution for reducing the production cost. Accordingly, it is the primary object of the present invention to provide a locker assembly for door boards, which maintains major structures of the conventional locker assembly, constructs a through aperture on the base, applies a common sliding unit, and connects the turning application rod to the sliding unit and to penetrate freely through the through aperture so as to movably perform unlocking various lock casings and locking assemblies.

In the present invention, the locker assembly for door boards is assembled to an outdoor space of a door board, in which the door board is equipped with one of an embedded lock casing, an embedded vertical extended-rod locking assembly and an exposed vertical extended-rod locking assembly. The door board further has a penetration hole. The embedded lock casing has a locking tongue and a turning unit for retrieving and extending the locking tongue. The embedded vertical extended-rod locking assembly has at least one first locking rod and a connection member for driving the first locking rod. The exposed vertical extended-rod locking assembly has at least one second locking rod. The locker assembly comprises a base, a rocker arm, a toggle and a sliding unit. The base is fixed to the door board and has a through aperture located in correspondence with the penetration hole. The rocker arm is pivotally connected to the base and is defined with a stroke of the rocker arm. The toggle is movably mounted on the base by being located at a position midway of the stroke of the rocker arm so as to be pushed by the rocker arm for performing a motion along a stroke of the toggle. The sliding unit is movably mounted on the base by being located at a position midway of the stroke of the toggle and further has at least one assembly-adjusting unit to adjust in accordance with one of the embedded lock casing, the embedded vertical extended-rod locking assembly and the exposed vertical extended-rod locking assembly and then to integrate one of a turning application rod and an assembled linking member, in which the sliding unit is pushed by the toggle to displace along a sliding stroke of the locker. In the present invention, the turning unit of the embedded lock casing, the connection member of the embedded vertical extended-rod locking assembly and the at least one second locking rod of the exposed vertical extended-rod locking assembly are located at corresponding positions midway of the sliding stroke of the locker.

In one embodiment of the present invention, the sliding unit further includes at least one connection rod, at least one sliding member and at least one restraint slot. The connection rod is connected with the sliding member. The restraint slot is located on the sliding member. The base further includes a base structure and a fixation base structure. The rocker arm is movably mounted on the base structure. The fixation base structure is close to the sliding unit and is mounted on the base structure at a position in the sliding unit. The fixation base structure further has a position member to penetrate through the restraint slot. In addition, the rocker arm is consisted of a depression portion, a pivotal portion and an action portion. The depression portion can perform a rotational displacement along the stroke of the rocker arm. The pivotal portion connecting the depression portion is pivotally mounted on the base structure and thus can pivot around the base structure. The action portion connecting the pivotal portion by neighboring to the toggle and the connection rod displaces rotationally along the stroke of the rocker arm so as to drive the toggle to rotate along the stroke of the toggle and further to push the connection rod to slide the sliding unit along the sliding stroke of the locker.

In one embodiment of the present invention, the action portion is mounted between the base structure and the sliding unit, the stroke of the toggle is a rotational path, and the sliding stroke of the locker is parallel to the door board.

Hence, by providing the locker assembly for door boards of the present invention, the turning application rod as well as the sliding unit can be implemented into the current door board structure, by movably locating the turning application rod through both the through aperture added to the base and the penetration hole added to the door board, such that the locking tongue or the locking rod can be reached for locking or unlocking. In addition, the sliding unit can also be applied to push the exposed vertical extended-rod locking assembly. Therefore, the locker assembly for door boards of the present invention can be applicable to various locking assemblies of the door boards, and thus the aforesaid problems in the background section can be successfully resolved.

All these objects are achieved by the locker assembly for door boards described below.

### BRIEF DESCRIPTION OF THE DRAWINGS

The present invention will now be specified with reference to its preferred embodiment illustrated in the drawings, in which:

FIG. 1 is a perspective view of a conventional locker assembly installed on a fire door;

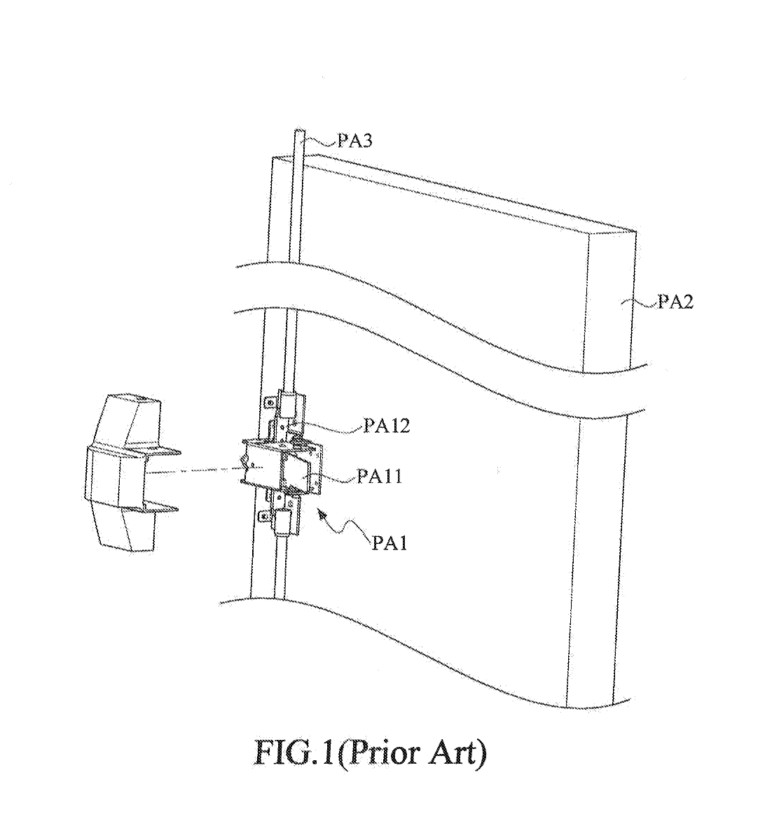

FIG. 2 is a perspective view of the conventional locker assembly of FIG. 1 and a fire door with an embedded vertical extended-rod locking assembly;

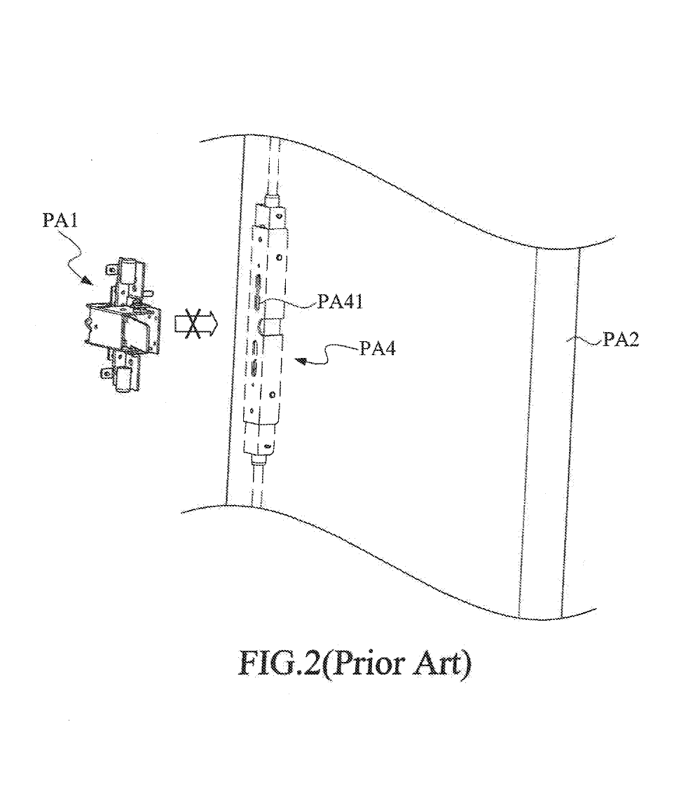

FIG. 3 is a perspective view of a first embodiment of the locker assembly for door boards in accordance with the present invention;

FIG. 4 is another view of FIG. 3;

FIG. 5 demonstrates separately the installation of the locker assembly for door boards of FIG. 3 on the door board;

FIG. 6 shows schematically the door board installed with the first embodiment of the locker assembly for door boards in accordance with the present invention;

FIG. 7 is another view of FIG. 6;

FIG. 8 is a perspective view of a second embodiment of the locker assembly for door boards in accordance with the present invention;

FIG. 9 is another view of FIG. 8;

FIG. 10 demonstrates schematically and separately a door board and the second embodiment of the locker assembly in accordance with the present invention;

FIG. 11 shows another view of FIG. 10, but in an assembled state; and

FIG. 12 is a perspective view of a third embodiment of the locker assembly for door boards in accordance with the present invention.

### DESCRIPTION OF THE PREFERRED EMBODIMENT

The invention disclosed herein is directed to a locker assembly for door boards. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

For various embodiments of the locker assembly for door boards in accordance with the present invention can be provided, yet in the following description of the present invention only three typical exemplary embodiments there-among are furnished for elucidating in details.

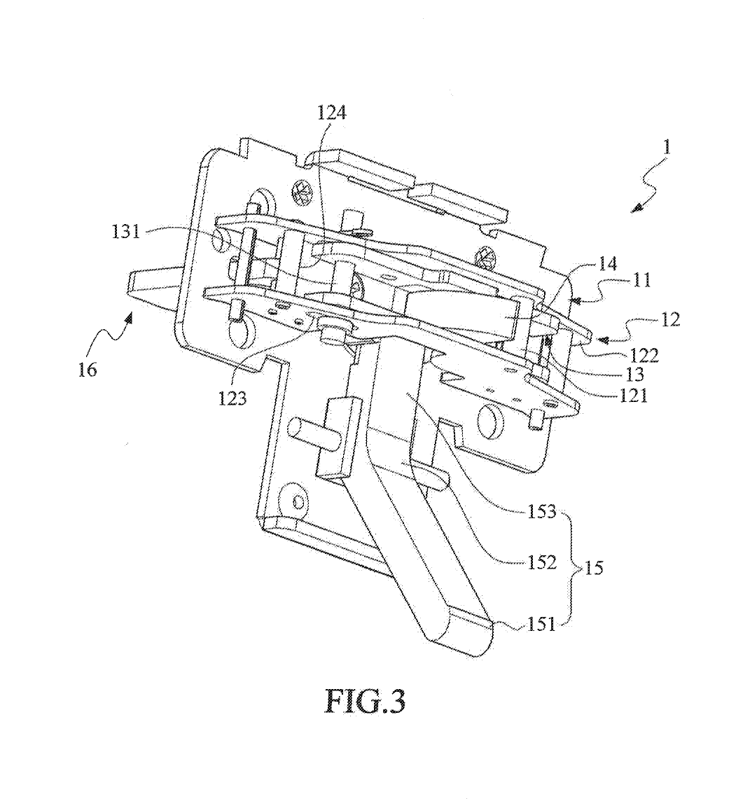

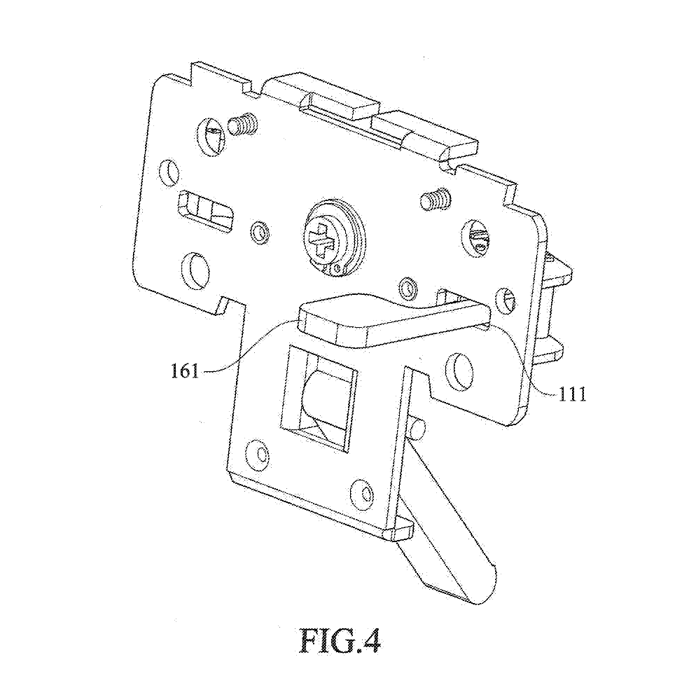

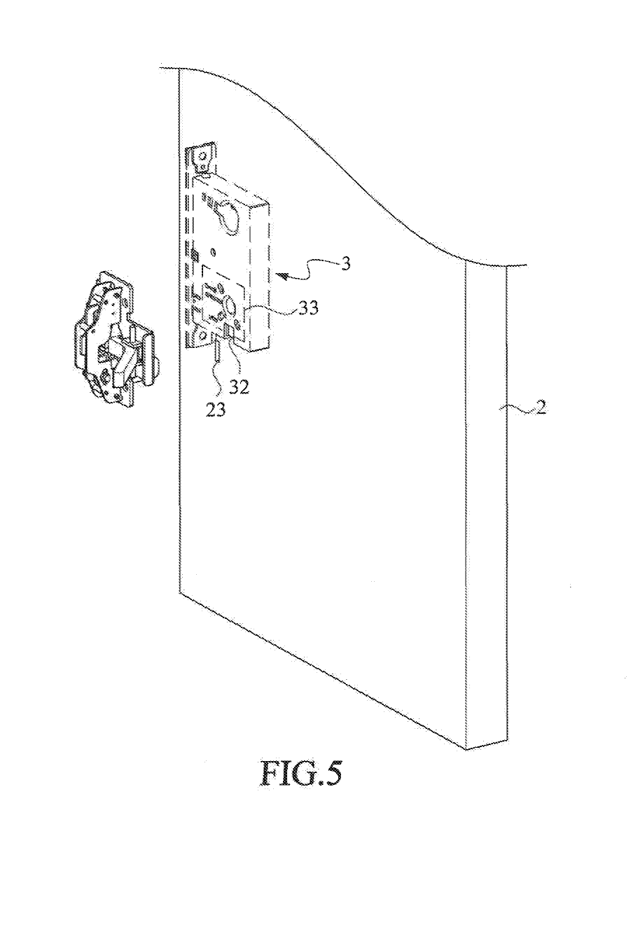

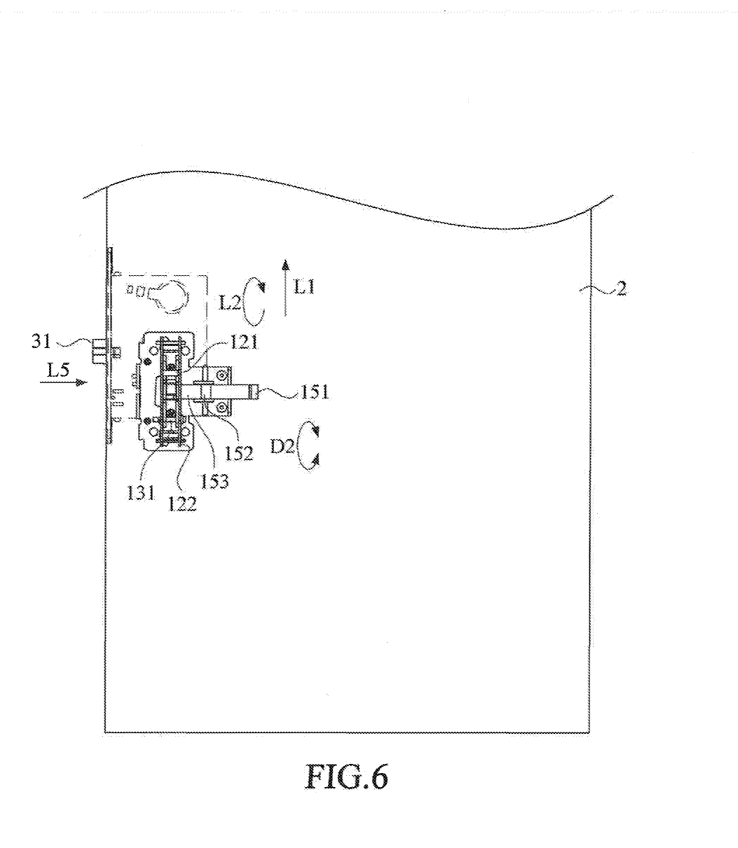

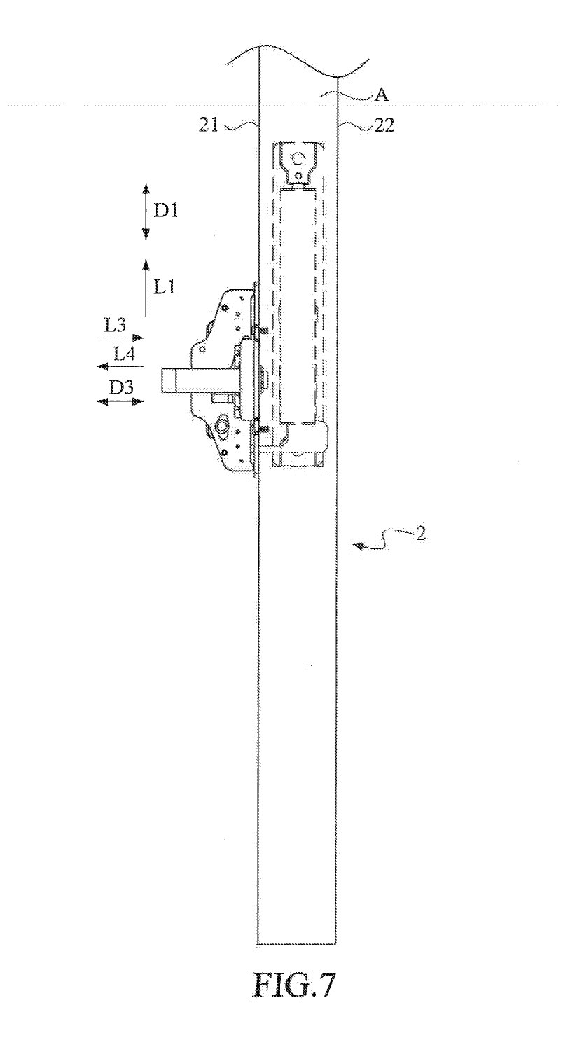

Refer now to FIG. 3 through FIG. 7, in which FIG. 3 is a perspective view of a first embodiment of the locker assembly for door boards in accordance with the present invention, FIG. 4 is another view of FIG. 3, FIG. 5 demonstrates separately the installation of the locker assembly of FIG. 3 on the door board, FIG. 6 shows schematically the door board installed with the first embodiment of the locker assembly, and FIG. 7 is another view of FIG. 6.

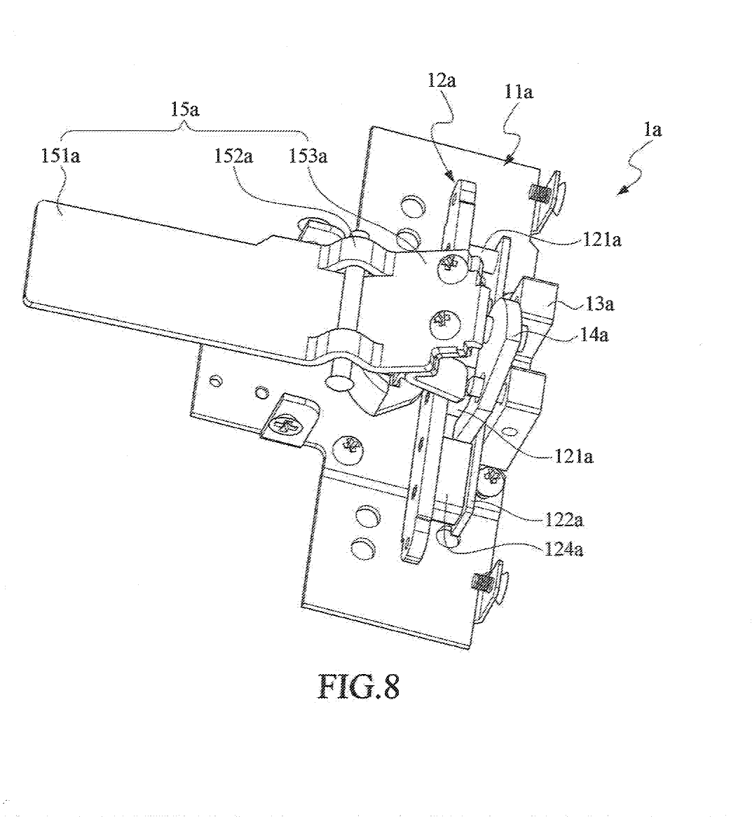

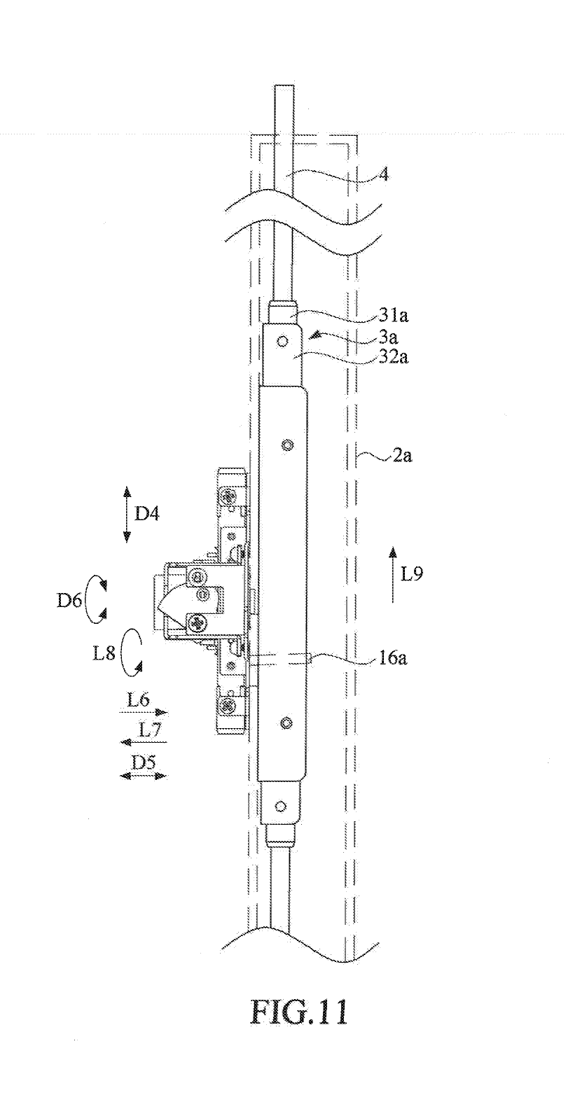

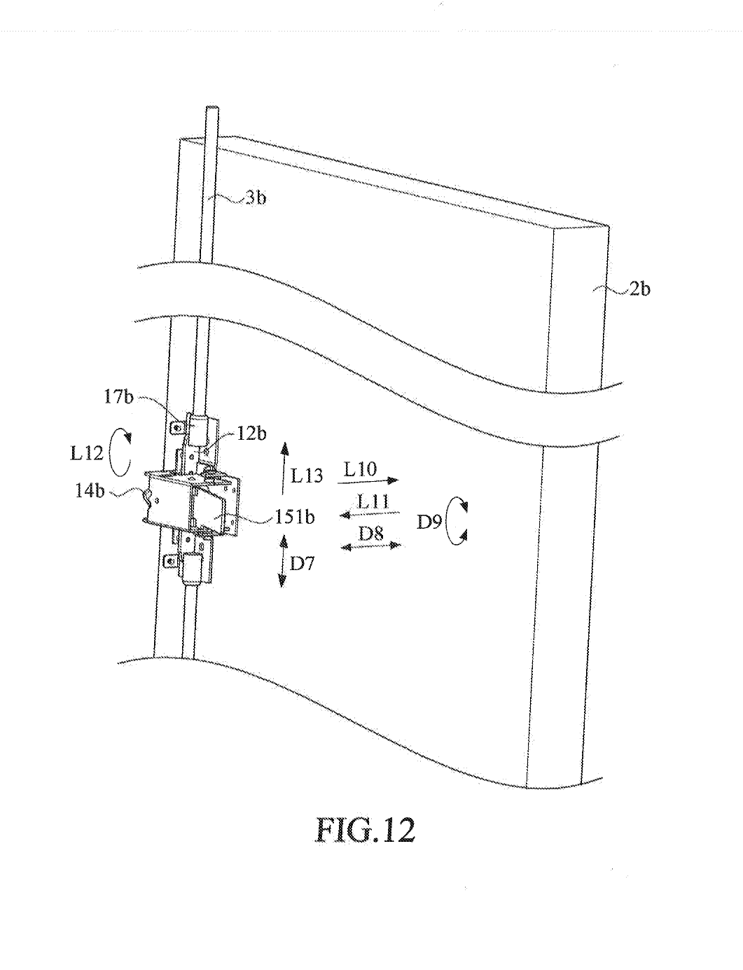

As shown, the first embodiment of the present invention provides a locker assembly for door boards 1 to be installed externally onto the door board 2. The door board 2 can be an existing fire door, and is typically consisted of a door plate 21 and another door plate 22 parallel to the former door plate 21 by a specific distance, as shown in FIG. 8. The interior space between the door plates 21, 22 is defined as an in-board space A. It is noted that the space out of the in-board space A is defined as the outdoor space of the first embodiment, including the space out of the door plate 21 and that out of the door plate 22. Further, the door board 2 can be a door including an embedded lock casing 3, an embedded vertical extended-rod locking assembly 3a as shown in FIG. 11 or an exposed vertical extended-rod locking assembly as shown in FIG. 12, and has a penetration hole 23.

In addition, the vertical extended-rod locking assembly defined herein is directed to the locker assembly having an upper locking point and a lower locking point, and each of the upper locking point and the lower locking point has correspondingly an unlocked position and a locked position. Namely, to the upper locking point, the locked position is located at an upper position, while the unlocked position is located at a lower position. On the other hand, to the lower locking point, the unlocked position is located at an upper position, while the locked point is located at a lower position.

In the first embodiment, the door board 2 is the one having an embedded lock casing 3. As shown, the embedded lock casing 3 is located fixedly in the in-board space A by interferential mounting or screw mounting. For those mounting techniques are well known to the art, so details thereabout are omitted herein. Further, the embedded lock casing 3 includes a locking tongue 31, an action aperture 32 and a turning unit 33. The action aperture 32 is close to the penetration hole 23 by a spacing per practical needs. The turning unit 33 is coupled with the locking tongue 31 by neighboring the action aperture 32. In the present invention, the turning unit 33 can be a cam, a linking bar, a gear or any combination thereof. Further, the turning unit 33 can be furnished with a resilient element. Similarly, for the embodiments of the turning unit 33 are already matured arts, so details thereabout are omitted herein. The only restriction upon the turning unit 33 of this first embodiment of the present invention is the transformation of the first-directional linear motion to the second-directional linear motion.

The locker assembly for door boards 1 includes a base (not shown in the figures), a sliding unit 12, a fixation base 13, a toggle 14, a rocker arm 15 and a turning application rod 16. The base can be simply defined to be the combination of a base structure 11 and the fixation base 13. The base structure 11 is fixed to the door board 2 by (but not limited to) a screw means, and has a through aperture 111 located in correspondence to the penetration hole 23. The fixation base 13 is extended, in a unique piece, from the base structure 11. Alternatively, a discrete element appropriately connected to the base structure 11 can also serve as the fixation base 13.

The sliding unit 12 movably coupled with the base structure 11 (in a vertical movement herein) has a sliding stroke of the locker D1, which is parallel to the door board as shown in FIG. 7. The turning unit 33 of the embedded lock casing 3 is located midway in the sliding stroke of the locker D1. The sliding unit 12 further includes at least one connection rod 121, at least one sliding member 122, at least one restraint slot 123 and at least one assembly-adjusting unit 124. The connection rod 121 is connected with the sliding member 122. The restraint slot 123 is constructed on the sliding member 122. Precisely, in this first embodiment, the sliding member 122 is consisted of two plates (not shown in the figures), each of which has one said restraint slot 123; and the connection rod 121 is connected between these two plates. The assembly-adjusting unit 124 is located between the two plates of the sliding member 122. In addition, the assembly-adjusting unit 124 is adjusted in accordance with the corresponding locking assembly of the embedded lock casing 3, the embedded vertical extended-rod locking assembly 3a or the exposed vertical extended-rod locking assembly for integrating one of a turning application rod 16 and an assembled linking member 17b.

The fixation base 13 neighboring the sliding unit 12 is connected to the base structure 11 at a position in the sliding unit 12, and has a position member 131 to penetrate the restraint slot 123 so as to define the sliding stroke of the sliding unit 12.

The toggle 14 movably connected to the fixation base 13 of the base is to push the connection rod 121. Namely, the toggle 14 is coupled to the fixation base 13 and located close to the connection rod 121. In addition, the toggle 14 is defined with a stroke of the toggle D2, is which is a rotational stroke (i.e. a pivotal path). The contour or shape of the toggle 14 is defined per practical needs, which is not limited to the shape shown in the illustrated embodiments. As shown in FIG. 3, the shape of the toggle 14 in the first embodiment is similar to a teardrop shape. Further, the sliding unit 12 is located midway of the stroke of the toggle D2. Precisely, the connection rod 121 of the sliding unit 12 is located at a place that the toggle 14 would hit while in undergoing within the stroke of the toggle D2.

The rocker arm 15 pivotally connected to the base structure 11 of the base is defined with a stroke of the rocker arm D3, in which the stroke of the rocker arm D3 crossing the toggle 14 is an arc-shape path. In the first embodiment, the rocker arm 15 has a depression portion 151, a pivotal portion 152 and an action portion 153. The depression portion 151 can be depressed to move within the stroke of the rocker arm D3, which is an arc-shape stroke centered at the fixed pivotal center for the pivotal portion 152. The pivotal portion 152 extended from the depression portion 151 is pivotally connected to the base structure 11 of the base. The action portion 153 extended further from the pivotal portion 152 to neighbor the connection rod 121 of the toggle 14 is located between the base structure 11 and the sliding unit 12. The action portion 153 can displace within the stroke of the rocker arm D3 so as to push the toggle 14 to rotate along the stroke of the toggle D2, such that the connection rod 121 can be driven to push the sliding unit 12 to slide along the sliding stroke of the locker D1.

The turning application rod 16 located close to the turning unit 33 is connected to the sliding unit 12. In the first embodiment of the present invention, the turning application rod 16 is assembled to the assembly-adjusting unit 124 by screwing, buckling or integrated as a unique piece. The turning application rod 16 penetrates freely through the penetration hole 23 and the through aperture 111 and is arranged properly without affecting the sliding movement of the sliding unit 12 along the sliding stroke of the locker D1. In addition, in the first embodiment of, the present invention, the turning application rod 16 further includes a hook portion 161 extended parallel to the first direction L1 of the door board 2, as shown in FIG. 7.

Referring now particularly to FIG. 5 through FIG. 7, while the locker assembly 1 is cooperated with the embedded lock casing 3, and when the depression portion 151 is depressed to move along the stroke of the rocker arm D3 in the second direction L3 (shown as an arrowed line for the rotational axis), the action portion 153 is then driven to rotate along the stroke of the rocker arm D3 in the third direction L4 (shown as an arrowed line for the rotational axis) so as to engage by contacting the toggle 14. The toggle 14 is thus pushed to rotate along the stroke of the toggle D2 in the rotational direction L2 to further rotate the connection rod 121 as a cam motion for driving the sliding member 122 of the sliding unit 12 to undergo motions within the sliding stroke of the locker D1 in the first direction L1. At this time, the position member 131 displaces along the restraint slot 123 in the first direction L1 so that the sliding member 122 can drive synchronously the turning application rod 16 to turn along the sliding stroke of the locker D1 in the first direction. L1 to have the hook portion 161 to approach the action aperture 32 and filially contact the turning unit 33. Simultaneously, the position member 131 is moved to be restricted at one end of the restraint slot 123, such that the turning unit 33 can turn the first direction L1 into the fourth direction L5 perpendicular to the first direction L1 so as to retrieve the locking tongue 31. Then, the door board 2 is unlocked. In the present invention, for the retrieval of the locking tongue 31 can be versatile embodied and such a technique is well known in the art, so details there-about are omitted herein.

Further, it is noted that, though the turning application rod 16 of the first embodiment provides the end hook portion 161 to contact at the turning unit 33, yet in some other embodiments the turning application rod 16 may be shaped as a coarser bar without a hook end and the penetration hole 23 is moved closer to the through aperture 111. Nevertheless, the design of the turning application rod 16 is actually simply a designer's choice per practical requirements.

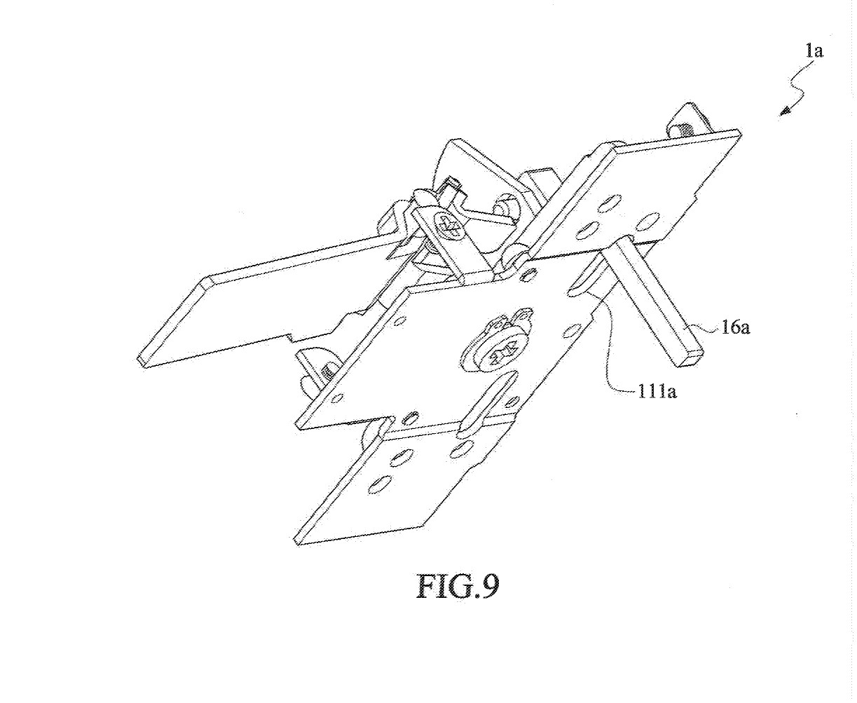

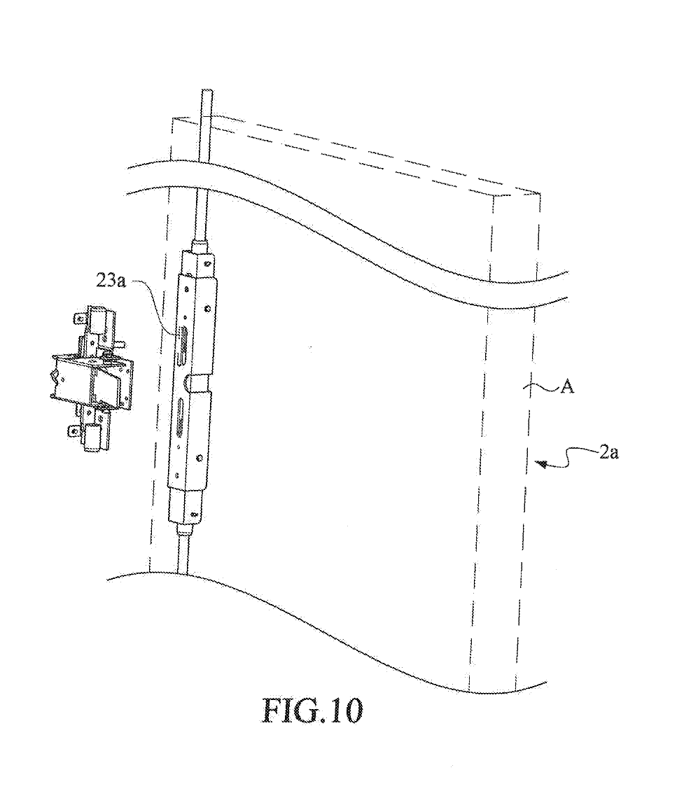

Refer now to FIG. 8 through FIG. 11, in which FIG. 8 is a perspective view of a second embodiment of the locker assembly for door boards in accordance with the present invention, FIG. 9 is another view of FIG. 8, FIG. 10 demonstrates schematically and separately a door board and the second embodiment of the locker assembly in accordance with the present invention, and FIG. 11 shows another view of FIG. 10 in an assembled state.

As shown, the second embodiment 1a of the locker assembly for door boards in accordance with the present invention is installed exteriorly to the outdoor space of the door board 2a, in which the door board 2a is almost the same as that in the first embodiment but, differently, is equipped with an embedded vertical extended-rod locking assembly 3a in the in-board space A. As shown, the door board 2a has a similar penetration hole 23a, and the embedded vertical extended-rod locking assembly 3a includes at least one first locking rod 31a and connection member 32a for driving the first locking rod 31a. Namely, the connection member 32a and the first locking rod 31a are coupled together.

As shown, the locker assembly 1a includes a base structure 11a, a sliding unit 12a, a fixation base 13a, a toggle 14a, a rocker arm 15a and a turning application rod 16 assembled to an assembly-adjusting unit 124a. The base structure 11a is fixed to the door board 2a and has a through aperture 111a located in correspondence with the penetration hole 23a. the connection member 32a of the embedded vertical extended-rod locking assembly 3a is located midway of the sliding stroke of the locker D4. Further, the major difference between the second embodiment 1a and the first embodiment 1 is that the sliding unit 12a of this second embodiment 1a does not have a restraint slot. Alternatively, a plurality of connection rods 121a (one shown in the figure) are included. Further, in this second embodiment 1 a, the fixation base 13a and the turning application rod 16a do not have a position member and a hook portion, respectively. Except for the aforesaid changes, all other elements in the second embodiment 1 a are resembled to those in the first embodiment 1 in both the connection relationship and the functions but slight difference in the shaping, and thus details there-about would be omitted herein.

Referring to FIG. 10 and FIG. 11, while the depression portion 151a of the second embodiment of the present invention is depressed to perform a pivotal motion along the stroke of the rocker arm D5 in the second direction L6 about the pivotal portion 152a, the action portion 153a is rotated along the stroke of the rocker arm D5 in the third direction L7 to contact at the toggle 14a so as to rotate the toggle 14a along the stroke of the toggle D6 in the rotational direction L8 and thus to have the connection rod 121a to slide the sliding member 122a of the sliding unit 12a along the sliding stroke of the locker D4 in the first direction L9, such that the turning application rod 16a can move synchronously in the first direction L9 and can further move the connection member 32a in a first direction L9 so as to drive the first locking rod 31a and the embedded rocker arm 4 to displace vertically in the first direction L9 for triggering the unlocking of the door board 2a. In addition, it is noted that, though the second embodiment performs the unlocking in the first direction L9, various unlocking means or directions already in the marketplace can be applied to unlock the door board 2a, and thus details thereabout for this mature art would be omitted herein.

Referring now to FIG. 12, a perspective view of a third embodiment of the locker assembly for door boards in accordance with the present invention is shown. In the third embodiment of the present invention, the locker assembly is applied to cooperate with an exposed vertical extended-rod locking assembly (not completely shown in the figures). As shown, this third embodiment of the locker assembly is totally resembled to the aforesaid second embodiment, and both of which are mounted outside to the door board 2b. The only difference in between is the application of the embodiments. In FIG. 12, the third embodiment is applied to the door board 2b equipped with an exposed vertical extended-rod locking assembly, while the second embodiment of FIG. 8 is applied to the door board 2a equipped with an embedded vertical extended-rod locking assembly. However, the penetration hole (not shown in the figures) is common to these two applications. As shown, the exposed vertical extended-rod locking assembly has at least one second locking rod 3b mounting midway to the sliding stroke of the locker D7. The assembled portion (not shown in the figure) at the end of the sliding unit 12b is connected with an assembled linking member 17b for the second locking rod 3b to be coupled by locking or screwing.

While the depression portion 151b of the third embodiment is depressed to rotate along the stroke of the rocker arm D8 in the second direction L10 (an arc-shape path), the action portion (not shown in the figures) is rotated along the stroke of the rocker arm D8 in the third direction L11 (an arc-shape path) so as to contact at the toggle 14b. The toggle 14b then follows the stroke of the toggle D9 in the rotational direction L12 to push the connection rod (not shown in the figures) so as to slide the sliding unit 12b along the sliding stroke of the locker D7 in the first direction L13, such that the sliding unit 12 can drive the second locking rod 3b to displace vertically in the first direction L13 for unlocking the door board 2b. Thereby, the door board 2b can be pushed to open.

Further, it is noted that, in commercial applications, the first embodiment of the locker assembly for door boards 1 can further includes the turning application rod 16a of the second embodiment and the assembled linking member 17b of the third embodiment, besides of the base structure 11, the sliding unit 12, the fixation base 13, the toggle 14, the rocker arm 15 and the turning application rod 16. In practice, in correspondence with the locking assembly for the door board, the choice of the turning application rod 16, the turning application rod 16a and the assembled linking member 17b can be determined for being assembled to the assembly-adjusting unit 124 of the sliding unit 12.

In summary, by providing the locker assembly for door boards of the present invention, the turning application rod as well as the sliding unit can be implemented into the current door board structure, by movably locating the turning application rod through both the through aperture added to the base and the penetration hole added to the door board, such that the locking tongue or the locking rod can be reached for locking or unlocking. In addition, the sliding unit can also be applied to push the exposed vertical extended-rod locking assembly. Hence, the locker assembly for door boards of the present invention can be applicable to various locking assemblies of the door boards, and thus the aforesaid problems in the background section can be successfully resolved.

While the present invention has been particularly shown and described with reference to a preferred embodiment, it will be understood by those skilled in the art that various changes in form and detail may be without departing from the spirit and scope of the present invention.

What is claimed is:

1. A locker assembly for door boards, assembled to an outdoor space of a door board, the door board being equipped with one of an embedded lock casing, an embedded vertical extended-rod locking assembly and an exposed vertical extended-rod locking assembly, the door board further having a penetration hole, the embedded lock casing having a locking tongue and a turning unit for retrieving/extending the locking tongue, the embedded vertical extended-rod locking assembly having at least one first locking rod and a connection member for driving the first locking rod, the exposed vertical extended-rod locking assembly having at least one second locking rod, the locker assembly for door boards comprising:
a base, fixed to the door board, having a through aperture in correspondence with the penetration hole;
a rocker arm, pivotally connected to the base, being defined with a stroke of the rocker arm;
a toggle, movably mounted on the base by being located at a position midway of the stroke of the rocker arm so as to be pushed by the rocker arm for performing a motion along a stroke of the toggle; and
a sliding unit, movably mounted on the base by being located at a position midway of the stroke of the toggle, further having at least one assembly-adjusting unit to adjust in accordance with one of the embedded lock casing, the embedded vertical extended-rod locking assembly and the exposed vertical extended-rod locking assembly and then to integrate one of a turning application rod 16 and an assembled linking member, the sliding unit being pushed by the toggle to displace along a sliding stroke of the locker;
wherein the turning unit of the embedded lock casing, the connection member of the embedded vertical extended-rod locking assembly and the at least one second locking rod of the exposed vertical extended-rod locking assembly are located at corresponding positions midway of the sliding stroke of the locker.

2. The locker assembly for door boards of claim 1, wherein the sliding unit further includes at least one connection rod, at least one sliding member and at least one restraint slot, the connection rod be coupled with the sliding member, the restraint slot being constructed on the sliding member.

3. The locker assembly for door boards of claim 2, wherein the base further includes a base structure and a fixation base structure, the rocker arm being movably connected with the base structure, the fixation base structure being connected with the base structure by neighboring to the sliding unit and mounted at a position in the sliding unit, the fixation base structure further having a position member to penetrate the restraint slot.

4. The locker assembly for door boards of claim 3, wherein the rocker arm further includes:
a depression portion, to move along the stroke of the rocker arm;
a pivotal portion, connecting the depression portion and mounted pivotally on the base structure; and
an action portion, connecting the pivotal portion by neighboring the toggle and the connection rod, the action portion being rotated along the stroke of the rocker arm so as to drive the toggle to rotate along the stroke of the toggle and further to have the connection rod to drive the sliding unit to slide along the sliding stroke of the locker.

5. The locker assembly for door boards of claim 4, wherein the action portion is located between the base structure and the sliding unit.

6. The locker assembly for door boards of claim 1, wherein the stroke of the toggle is a rotation path.

7. The locker assembly for door boards of claim 1, wherein the sliding stroke of the locker is parallel to the door board.
